(19) United States
(12) Patent Application Publication
(10) Pub. No.: US 2008/0234096 A1
(43) Pub. Date: Sep. 25, 2008

(54) Hybrid Utility Vehicle

(75) Inventors: Rajesh Joshi, Solon, OH (US); James Green, Berea, OH (US); Scott C. Bly, Parma, OH (US); Anthony J. Williams, Evans, GA (US)

Correspondence Address: WEGMAN, HESSLER & VANDERBURG, 6055 ROCKSIDE WOODS BOULEVARD, SUITE 200, CLEVELAND, OH, 44131, US

(73) Assignee: MTD Products Inc, Valley City, OH (US)

(21) Appl. No.: 11/662,819

(22) PCT Filed: Sep. 30, 2005
(86) PCT No.: PCT/US05/35238

§ 371 Date: Mar. 7, 2008

Related U.S. Application Data
(60) Provisional application No. 60/614,569, filed on Sep. 30, 2004.

(51) Int. Cl. B60K 6/22

(52) U.S. Cl. 477/3; 903/915

(57) ABSTRACT

A serial hybrid drive system for off-road utility vehicles and/or riding tractors including one or more electric motors (8, 8a, 8b) for driving the vehicle. The motors are connected to the driven wheels (11), with or without individual gear boxes 9a, 9b) or transmissions, to turn the wheels. The vehicle includes an electric generator (4) connected to the vehicle engine (2) for supplying power to a fast charging battery pack (6), which in turn feeds power to the motors. One or more motors may also be provided for operating accessory implements of the vehicle. These motors and vehicle generator receive operational instructions from one or more controllers (14, 16, 18), which may be programmed to adjust personality settings for the drive system.

### CROSS REFERENCE TO RELATED APPLICATION

This application claims the priority benefit of U.S. Provisional Patent Application Ser. No. 60/614,569 filed Sep. 30, 2004.

### BACKGROUND OF THE INVENTION

1. Field of Invention

The present invention relates to the field of hybrid gas-electric vehicles, and more particularly relates to a hybrid power system for controlling drive of an off-road utility vehicle and/or riding tractor, and for controlling operation of accessory cutting implements or other attachments connected to the hybrid power system of the vehicle.

2. Description of Related Art

Serial hybrid drives for motor vehicles typically include an internal combustion engine for driving an electric generator, and the generator provides electricity to a battery that supplies power to an electric motor that turns a transmission, and the transmission turns the wheels. Because of the conversion of the whole of mechanical energy into electrical energy and back into mechanical energy, hybrid drives of this type typically require complex mechanical and electrical designs, especially when they are intended to produce efficient modes of operation to reduce fuel consumption and/or prolong battery life. There has been an increasing trend in battery powered or hybrid vehicle production toward the use of separately excited DC motors due to the availability of relatively low-cost speed control possibilities, although other types of electric motors such as permanent magnet DC motors could also be used. The efficiency of known hybrid drive systems has not been entirely satisfactory for all applications, especially with respect to off road utility vehicles and/or riding tractors having accessory vegetation cutting implements or other attachments connected to the hybrid power system of the vehicle. Providing an efficient hybrid drive and power system for off-road utility vehicles and/or riding tractors (e.g. riding lawn mowers) that is cost-effective and convenient to operate has heretofore been difficult to achieve.

### SUMMARY OF THE INVENTION

Exemplary embodiments of the present invention provide a novel drive system for a hybrid off road utility vehicle and/or riding tractor which integrates a mechanical transaxle and one or more electric drive motors and at least one electronic controller for controlling operation of the motors and vehicle generator to efficiently supply power to the motors from the vehicle engine through one or more fast charging batteries. In these exemplary embodiments, the electric drive motors for driving the wheels may be connected to a transmission which turns the wheels, or the motors may be connected directly to the driven wheels, with or without individual gear boxes and/or a transmission. The vehicle generator supplies power to the batteries as commanded by the generator controller, and the generator may also supply DC power to a DC 12V converter that can be used for accessory power and to the input of an electrical inverter that has an output to standard electric utility AC outlets that can be used to power auxiliary equipment.

The motor controller receives input from a plurality of operational parameters such as the vehicle accelerator pedal and mode switch to control speed and drive characteristics of the vehicle, and to display operational signals to the operator of the vehicle. In one exemplary embodiment of the invention, the motor controller and generator controller are configured in a master-slave relationship. In other embodiments, the controllers could be integrated into one central vehicle controller. In addition, a third vehicle controller could be used, with the third controller being configured as the “master”, and both the motor controller and generator controller being configured as “slaves”.

In addition to the vehicle drive motors, one or more electric motors may be used to drive accessory vegetation cutting implements and/or attachments such as front blade lift/angle, rear tiller, snow plows, etc. Each of these additional motors could be controlled through separate controllers or through the main motor, generator, and/or vehicle controller to provide functionality such as speed control of the cutting implements as well as turning the accessories off and on in response to commands from the operator.

One embodiment of the present invention provides a main drive system which consists of a mechanical transaxle with a separately excited DC motor, although other embodiments contemplate use of a permanent magnet DC motor. Energy storage will be accomplished through a series of fast charging batteries. Power restoration may be achieved via an onboard generator, and alternate power restoration may be realized through the use of an optional onboard charger. Regenerative braking via the motor will contribute to battery recharge. The system provides auxiliary power in the form of 12-volt DC (converter) and 120-volt AC (inverter) power outlets for powering accessory equipment.

The vehicle also includes a three-position mode switch for selecting three different modes of operation. A first mode is an all-electric mode of operation. A second mode is a generator ‘on’ mode wherein the generator provides power to the battery pack. A third mode is a generator ‘on as needed’ mode wherein the vehicle can be operated in the all-electric mode, but the generator will automatically turn on to charge the batteries as needed.

These and other objects, features, and advantages of the present invention will become apparent to one skilled in the art upon examination and analysis of the following description in view of the accompanying drawings.

### BRIEF DESCRIPTION OF THE DRAWINGS

FIGS. 1 and 2 illustrate a system layout for a hybrid drive and power system in accordance with exemplary embodiments of the present invention;

FIG. 3 illustrates a dash-board layout comprising user control switches and display units in accordance with the present invention;

FIGS. 4 and 5 are block schematic diagrams illustrating a hybrid drive and power system in accordance with exemplary embodiments of the present invention.

### DETAILED DESCRIPTION OF THE INVENTION

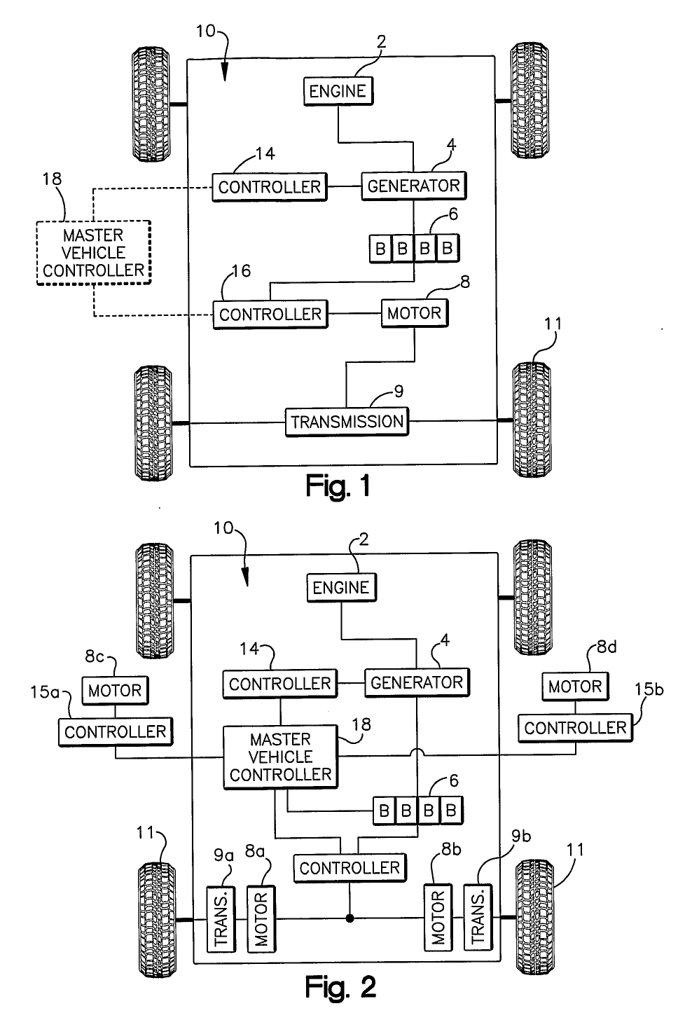

FIGS. 1 and 2 illustrate exemplary system layouts for serial hybrid vehicle drive and power systems in accordance with the present invention. In FIGS. 1 and 2, the drive system 10 of the vehicle employs an internal combustion engine 2, and an associated electric generator 4 supplying power to a series of batteries 6 which in turn are connected to a motor controller 16, which in turn is connected to one or more electric DC motors 8 to turn the driven wheels 11. Although the present embodiments employ a gasoline powered internal combustion engine 2 to power the generator 4, it is understood that many other types of engines could be selected, such as fuel cells running on hydrogen or other sources of energy, or engines that run on diesel, military fuel, propane, natural gas, etc., without departing from the broader scope of the present invention.

In FIG. 1, a transmission 9 is connected between the driven wheels 11 and motor 8 to drive the wheels 11. Alternatively, as shown in FIG. 2, a pair of motors 8a, 8b could be connected to the wheels 11 through individual gear boxes 9a, 9b respectively, to drive the driven wheels 11. It is also understood that the motors 8a, 8b could be connected directly to the driven wheels 11 without the use of individual gear boxes 9A, 9B or transmission 9.

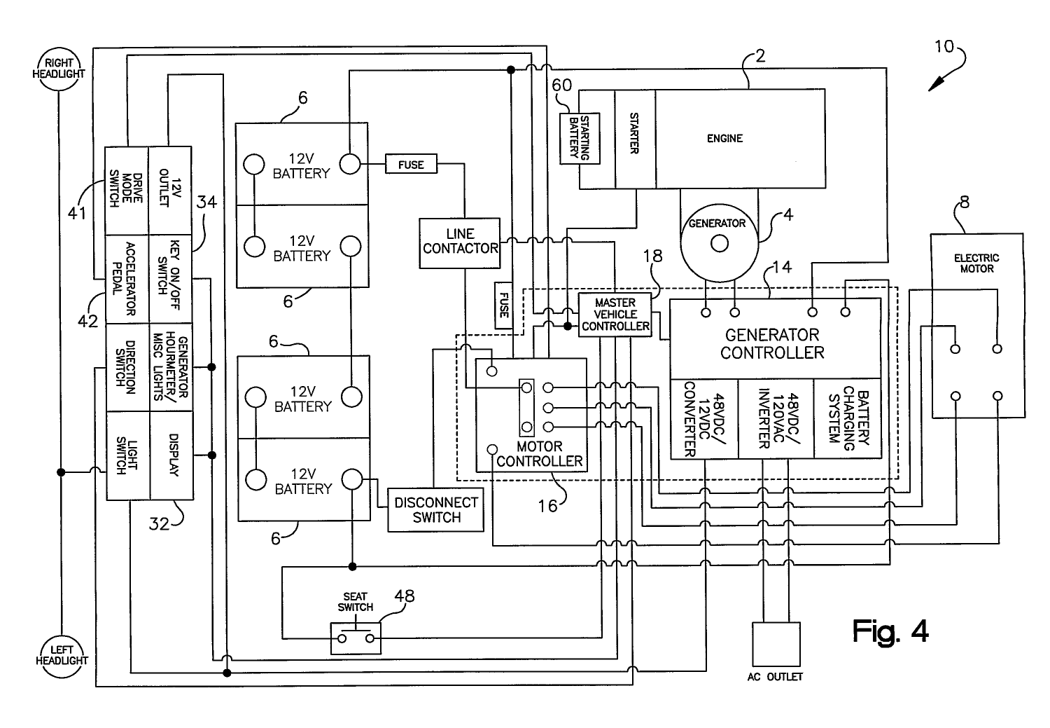

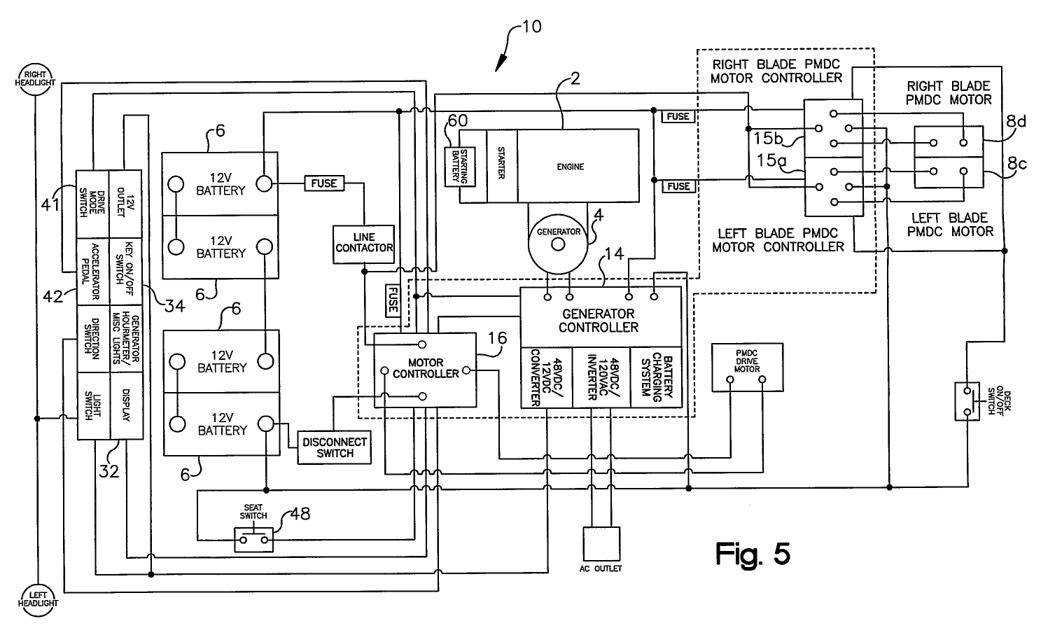

The motors 8 could be of many different types, with separately excited DC motors and/or permanent magnet DC motors being chosen for use in the exemplary embodiments described herein. The battery pack 6 employs fast charging batteries, for example, pure lead or advanced lead acid batteries which allow the batteries to go from a full discharge to a full charge in less than about two hours. Lithium ion or other advanced batteries that allow fast recharge could also be used and are considered within the scope of the present invention. As shown in FIGS. 4 and 5, the vehicle may also include a starting battery 60 that starts the internal combustion engine, although the starting function could also be provided by the main battery pack 6.

The generator 4, which may be a fixed or variable speed generator, provides sufficient power to charge the battery pack 6 from a fully discharged state to a fully charged state in less than about two hours with the vehicle stopped and not using power. An optional onboard charger can be used that would charge the batteries from fully discharged to fully charged in approximately eight to twelve hours, either to reduce fuel consumption or to prolong battery life.

Referring again to FIGS. 1 and 2, the generator 4 and motor 8 are controlled by an electronic generator controller 14 and motor controller 16, respectively. The controllers 14, 16 may be configured in a master-slave relationship with one of the controllers being configured as the master, and the other one being configured as the slave. However, as shown in FIGS. 1 and 2, an optional third vehicle controller 18 could be used as the master, with the generator controller 14 and the motor controller 16 being configured as slaves. In addition, the controllers 14, 16 could be integrated into one central controller as generally indicated by the dotted lines in FIGS. 4 and 5.

Turning now to FIG. 2, additional electric motors 8c, 8d are employed to drive cutting blades (not shown) of a hybrid vehicle in addition to the motor or motors used to drive the vehicle. Each of these additional motors 8c, 8d would be controlled through separate controllers 15a, 15b or through the main motor, generator, or master vehicle controllers. The blade motor controllers 15a, 15b could provide functionality such as speed control of the blades as well as turning them off and on in response to input from the operator. In addition, one or more electric motors and associated controllers may be used to operate vehicle attachments such as front lift/angle, rear tillers, snow plows, etc. As mentioned above, the functions of all these controllers could be integrated into one central vehicle controller.

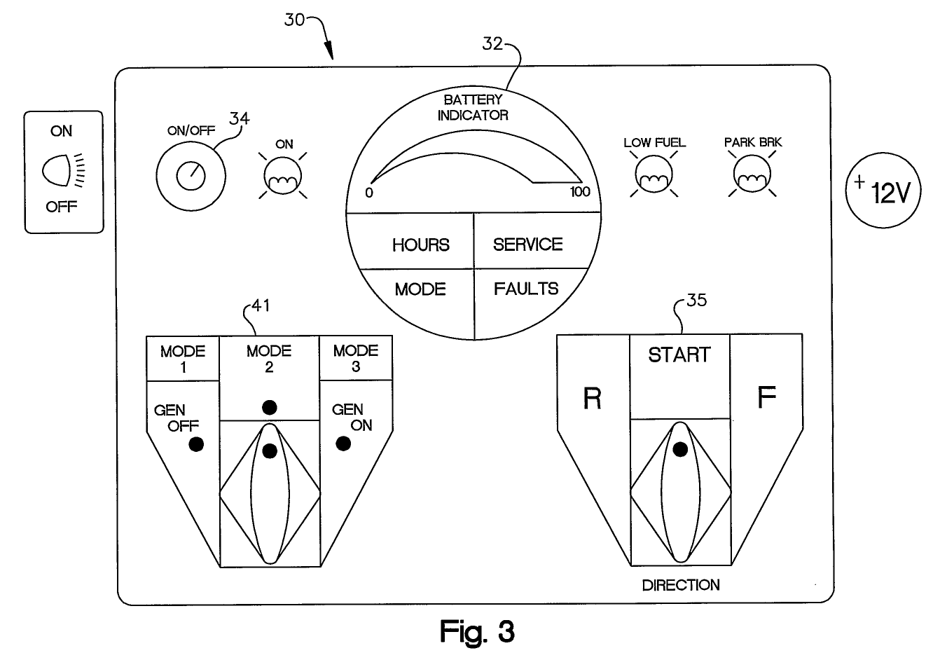

FIG. 3 illustrates an exemplary dashboard configuration comprising user control switches and display units for the hybrid vehicles of the present invention. The motor and/or generator controllers provide outputs to an electronic display 32 and/or instrument warning lights to provide information to the user such as state of battery charge; service needed; vehicle, motor, or generator fault codes; and total hours of vehicle, motor, and/or generator operation.

The vehicle also includes a three-position mode switch 41 for selecting three different modes of operation. It is understood that additional or fewer modes of operation may be provided for different applications. It is also noted that the names used to describe the following modes of operation (e.g. stealth, hybrid, auto) are selected for convenience only. These names are not intended to be limiting in any way, and may be subject to change.

A first mode of operation is an all-electric mode. This mode may also be referred to as stealth mode. The operator will select this mode via the “drive mode” switch 41 and the vehicle will operate using power from the batteries only. Regenerative braking will be the only in-use method of adding energy back into the battery bank. This will enable use indoors and in noise sensitive environments.

A second mode is a generator ‘on’ mode wherein the generator provides power to the battery pack. This mode will be generator-enhanced electric operation, and may also be referred to as a hybrid mode of operation. As an alternative to “stealth” mode, the operator may select the hybrid mode via the “drive mode” switch 41. The vehicle will operate using both power from the batteries and the generator simultaneously, whether driving or parked. The following describes two exemplary scenarios of operation under the second (i.e. hybrid) mode of operation.

Scenario A—Operator drives vehicle continuously: The generator will be on and running at full speed. This will reduce the amount of battery power consumption, and extend the range of the vehicle. The battery power will add a boost when accelerating and when climbing hills. It will provide power requirements past what is offered by the generator.

Scenario B—Operator parks vehicle to work: The generator will be on and will provide the amount of power requested by the batteries for recharging and the operator for working. The batteries will charge at the required output (e.g. up to about 3 kW). However, some power will be diverted when the operator requests power (e.g. up to about 20 A at 120 VAC) for using AC power tools, such as string trimmers, drills, etc. This will allow the vehicle to recharge while the operator works, thus extending run time while still benefiting the user.

A third mode of operation is a generator ‘on as needed’ mode. This mode may also be referred to as an ‘auto’ mode of operation. This mode will enable the vehicle to be operated in the electric mode until the vehicle controller determines a boost is required to maintain performance. At that time, the generator will be started to extend the range. If the battery charge reaches full while the operator is still present in the seat, the controller will shut down the generator and continue all-electric operation. There will be an operator presence seat switch 48 that will disable the generator when the operator leaves the seat. This will prevent the occurrence of the generator coming on unexpectedly when the vehicle is unattended, such as when the vehicle is parked in a closed garage and/or not shut down properly.

The generator or motor controllers can have additional features to receive input from a key fob used in conjunction with key switch 34 to allow for different vehicle operation using different keys, such as for child versus adult operation. Such a system could allow for slower operation of the vehicle; for instance, with a younger driver compared to an adult. The motor and/or generator controller can also be accessed for service or factory set up using a handheld device that communicates with the controller over the specific controller communication protocol or the general communication bus of the vehicle. The motor and generator controllers communicate with each other using a communication bus structure such as, but not limited to, the controller area network (CAN) bus typically used in automotive applications. In the present exemplary embodiments, with a standalone vehicle controller that is separate from the motor and generator controllers, the vehicle controller would communicate with each of the other controllers using one or more communication bus protocols. The vehicle also includes a direction switch 35 that allows the user to select from the forward and reverse directions of motion. As shown in FIG. 3, the switch 35 is placed in the middle position to start the vehicle and/or to reset one or more system faults. There could also be other means of resetting system faults, for example by way of the key switch 34.

Referring now to FIGS. 4 and 5, the motor controller 16 responds to commands from the drive mode switch 41, accelerator pedal 42 and seat switch 48 to provide motor drive controls for controlling the speed of the vehicle and to display signals such as fault signals on the display 32 to the operator. Regenerative braking is used which puts energy back into the batteries when the vehicle is slowed down. The motor controller has control parameters (i.e. personality settings) that can be configured at the factory or at the servicing dealer to control the operating characteristics of the vehicle such as acceleration and deceleration rates, top speed, etc.

The generator controller 14 has an internal battery state of charge algorithm, or battery discharge indicator (BDI) that is used to display the state of charge to the user and to turn on the generator. The generator (or master) controller employs known algorithms to discount transient voltage spikes and avoid hysterisis problems in order to determine an average battery voltage level during operation. This information is then used by the controller to automatically activate or deactivate the generator in accordance with predetermined threshold battery voltage levels. As a result of monitoring the depth of discharge and recharge cycle of the batteries, the batteries will hold their range longer and will not need to be replaced as often. Optionally, the generator controller 14 employs a DC-DC converter to provide 12 VDC power to the headlights, accessories, and optional DC power plug. The generator controller 14 also may contain a DC-AC inverter to provide 120 VAC/60 Hz or 230 VAC/50 Hz power to an outlet for standard U.S. or European power outlets. This can be used to run accessory tooling, AC radios, etc.

In one exemplary embodiment, the present invention incorporates a separately excited DC motor 8 to drive a mechanical transaxle 9 to drive the associated drive wheels 11. The electric motor 8 is connected and controlled by a motor controller 16, such as controllers of the type available from Sevcon. Note, a description of such controllers originates with the Sevcon operation manuals, the disclosures of which are hereby incorporated by reference herein.

The motor controller 16 is microprocessor based with flexible software and set up options. The motor controller has the capability of serial communication (i.e. CAN). Features of the motor controller 16 include direction changing, regenerative braking, field weakening, speed control, and high frequency silent operation.

A handheld calibrator adjustment unit (not shown) is used to make adjustments to the controller and select configurations. The calibrator is also used as a diagnostic tool displaying the status of all voltages, currents, and temperatures within the controller together with the condition of all the controllers switch and analog inputs.

Regenerative braking provides vehicle braking by controlling the motor as a generator and returning the generated energy to the battery. Regenerative braking is attempted at all speeds. The switching frequency in regeneration is high frequency and silent. Additional armature braking Mosfets are connected in parallel with the armature and switched at high frequency to regeneratively brake the motor below base speed. Regenerative braking is automatic above the base speed when the field current is increased or when field current is constant and the motor accelerates, for example, when encountering a downward slope.

In the foregoing specification, the invention has been described with reference to specific exemplary embodiments thereof. It will, however, be evident that various modifications and changes may be made thereunto without departing from the broader spirit and scope of the invention therein. For example, although the present invention has been described with reference to three different modes of operation, more or fewer modes could be provided without departing from the scope of the invention. It is understood that even though numerous characteristics and advantages of the present invention have been disclosed, other modifications and alterations are within the knowledge of those skilled in the art without undue experimentation and are to be included within the scope of the appended claims.

What is claimed is:

1. A drive system for a vehicle, comprising:
at least one drive wheel for propelling the vehicle;
at least one electric drive motor connected to the drive wheel such that the motor drives rotation of the wheel;
at least one controller;
at least one battery connected to the controller such that the battery supplies electrical power to the drive motor;
a generator connected to the battery such that the generator converts mechanical power into electrical power and supplies this electrical power to the battery;
an internal combustion engine connected to the generator such that the internal combustion engine supplies mechanical power to the generator;
wherein said at least one controller is connected to the generator and the drive motor for controlling operation of the vehicle and for adjusting control parameters of the drive system.

2. The drive system of claim 1, further comprising a multi-position mode switch for selecting a first, second or third mode of vehicle operation.

3. The drive system of claim 2, wherein said vehicle includes at least one accessory implement, said drive system further comprising at least one implement motor for driving said implement, said implement motor being connected to said controller for controlling operation of said implement.

4. The drive system of claim 3, further comprising a DC converter connected to the controller such that the converter provides auxiliary DC power to the vehicle.

5. The drive system of claim 4, further comprising an AC inverter connected to the controller such that the inverter provides auxiliary AC power to the vehicle.

6. The drive system of claim 5, wherein said controller comprises a motor controller and a generator controller for controlling said drive motor and generator, respectively.

7. The drive system of claim 6, wherein said motor controller and said generator controller are configured in a master-slave relationship.

8. The drive system of claim 7, further comprising a vehicle controller, wherein said vehicle controller is the master controller, and said motor controller and generator controller are slave controllers.

9. The drive system of claim 8, further comprising a key fob to limit operation of the vehicle.

10. The drive system of claim 9, further comprising regenerative braking for supplying power to said battery when said vehicle is slowed down.

11. The drive system of claim 10, further comprising a handheld calibrator unit to program said personality settings.

12. The drive system of claim 11, further comprising a CAN bus for facilitating communication between said controllers.

13. The drive system of claim 12, further comprising a display unit for displaying operational parameters of said vehicle.

14. The drive system of claim 13, further comprising at least one transaxle connected to said at least one drive wheel, wherein said drive motor turns said transaxle, and said transaxle turns said drive wheel.

15. The drive system of claim 14, wherein said batteries are capable of being fast charged.
